(19) United States
(12) Patent Application Publication
(10) Pub. No.: US 2012/0118171 A1
(43) Pub. Date: May 17, 2012

(54) BREAD PRODUCT EDGE TOASTING SHIELD FOR CONVEYOR TOASTER

(75) Inventors: LOREN VELTROP, CHICAGO, IL (US); DONALD VAN ERDEN, WILDWOOD, IL (US)

(73) Assignee: PRINCE CASTLE LLC, CAROL STREAM, IL (US)

(21) Appl. No.: 13/338,487

(22) Filed: Dec. 28, 2011

Related U.S. Application Data
(62) Division of application No. 12/556,445, filed on Sep. 9, 2009.

(51) Int. Cl. A47J 37/08

(52) U.S. Cl. 99/386

(57) ABSTRACT

Edges of English muffins and certain other types of bread products known to burn during toasting are protected from burning by a bread product edge toasting shield. One embodiment of the bread product edge shield is a baffle formed of orthogonal or substantially orthogonal metal strips. A second embodiment is a cylindrical tube. The edge toasting shield blocks infrared energy waves that would otherwise be incident upon the bread product edges at angles of incidence less than about eighty degrees relative to horizontal.

### RELATED APPLICATIONS

This application is a divisional of, and claims the filing date priority of, application Ser. No. 12/556,445, filed Sep. 9, 2009, and which is entitled “Bread Product Edge Toasting Shield.”

### BACKGROUND

Many restaurant menu items include toasted bread products. Toasted bread products are considered herein to include toasted English muffins, toasted sliced breads, toasted sandwich rolls and toasted bagels.

It is well known that toasted bread products have a distinctly different flavor and color than do the same products prior to toasting. Toasting also changes a bread product's color and its texture. Toasting and toasted bread products also give off a pleasing aroma.

Toasting is well-known to be a non-enzymatic reaction between carbohydrates and proteins that occurs upon heating. While toasting can be performed by contact heating, many bread products are preferably toasted using infrared (IR) energy, such as the IR emitted from electrically-heated filaments.

Bread products with rough or irregular surfaces are ill-suited for contact toasting and therefore usually toasted using emitted infrared energy. An English muffin half is one type of bread product that is usually toasted using infrared instead of contact heating because the surface of an English muffin half, i.e., one of the two portions created when an English muffin is cut completely through its substantially circular edge, is irregular. The irregular surface of an English muffin half is made up of valleys and ridges attributable to the ingredients and how it is made.

Whenever the toasting process goes too far or too long, carbohydrates and/or proteins oxidize completely and form carbon. Carbon absorbs light. Surfaces of a burned bread product therefore appear black.

Burning is considered to be the thermally-induced oxidation of carbohydrates and/or proteins, to a point where the carbon content of the bread product surface is high enough to absorb visible light that impinges on the bread product surface and which makes the surface of the bread product appear to an ordinary observer to be black. Burnt breads like English muffin halves have a taste, texture, appearance, smell and color that most people dislike.

Since the valleys and ridges of an English muffin surface are inherently separated from an infrared energy source by different differences, and since the temperature and moisture content of English muffins varies from batch to batch and even from muffin to muffin, consistently toasting different English muffin halves quickly and uniformly using IR has proven to be difficult. It has been observed that when English muffins are subjected to IR, as happens in most commercial toasters, the peripheral edge of English muffin halves tend to burn first, i.e., sooner and faster than do the surfaces of an English muffin half, inside the peripheral edge. An apparatus and/or method that reduces or eliminates the tendency of bread product edges, such as the edges of an English muffin half to burn during toasting would be an improvement over the prior art.

### BRIEF DESCRIPTION OF THE DRAWINGS

FIG. 1 is a perspective view of a toaster or broiler for toasting bread products and other foods and showing bread products in a bread product edge toasting shield on a spatula;

FIG. 1A is a side view of an English muffin, not to scale but showing the edge of an English muffin half;

FIG. 2A, 2B and 3, are side views of a heating element shown in FIG. 1, bread products beneath the heating element, infrared wave fronts emitted from the element and bread product edge toasting shields;

FIGS. 4A, 4B and 5 are cross-sectional views through the toaster of FIG. 1, showing bread products beneath three heating elements, infrared wave fronts emitted from the elements and bread product edge toasting shields;

FIG. 6 is a perspective view of an alternate embodiment of bread product edge toasting shields;

FIG. 7 is a sectional view through FIG. 6 showing bread products beneath the heating element, infrared wave fronts emitted from the element and bread product edge toasting shields;

FIG. 8 is a perspective view of an alternate embodiment of a toaster or broiler having bread product edge toasting shields mounted to the cabinet of the toaster and a spatula having bread product edge toasting shields mounted to it;

FIGS. 9A and 9B and 10 are side views of the toaster of FIG. 8 taken through section lines 9-9 showing bread products beneath the cabinet-mounted heating elements, infrared wave fronts emitted from the element and, the IR blocking effectuated by the bread product edge toasting shields;

FIGS. 11A, 11B and 12 are cross-sectional views through the toaster of FIG. 8 taken through section lines 11-11 in FIG. 8, when the spatula shown in FIG. 8 is placed within the toaster cabinet, and showing bread products beneath three heating elements, infrared wave fronts emitted from the elements and the IR blocking effectuated by the bread product edge toasting shields;

FIG. 13A shows a first embodiment of a conveyor toaster having bread product edge shields that are configured such that a first part of the shields are attached to the toaster cabinet such that they pass through spaces between second shield parts attached to the conveyor belt;

FIG. 13B shows an alternate embodiment of the conveyor toaster shown in FIG. 13A wherein the edge shield is attached to conveyor segments; and

FIG. 14 shows an alternate embodiment of a conveyor toaster having bread product edge shields attached to the conveyor.

### DETAILED DESCRIPTION

Toasters as well as broilers are considered herein to be devices usable for toasting bread products using infrared energy. The infrared energy to toast bread products is typically supplied by an electrically-heated filament, however, alternate toaster embodiments use gas-fired infrared emitters.

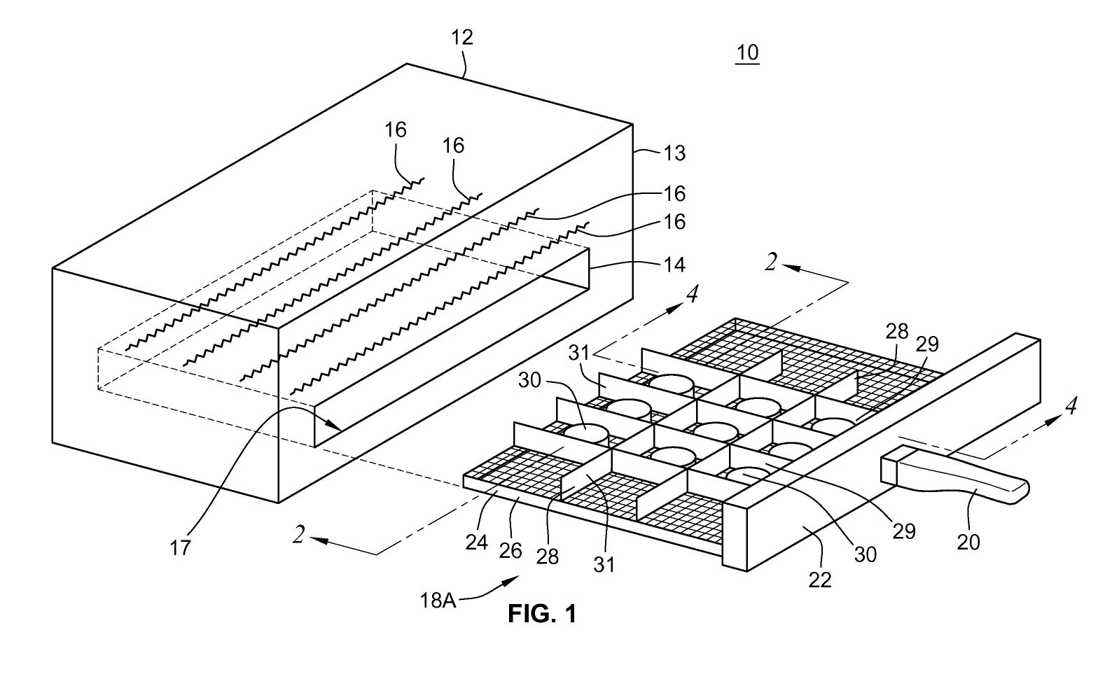

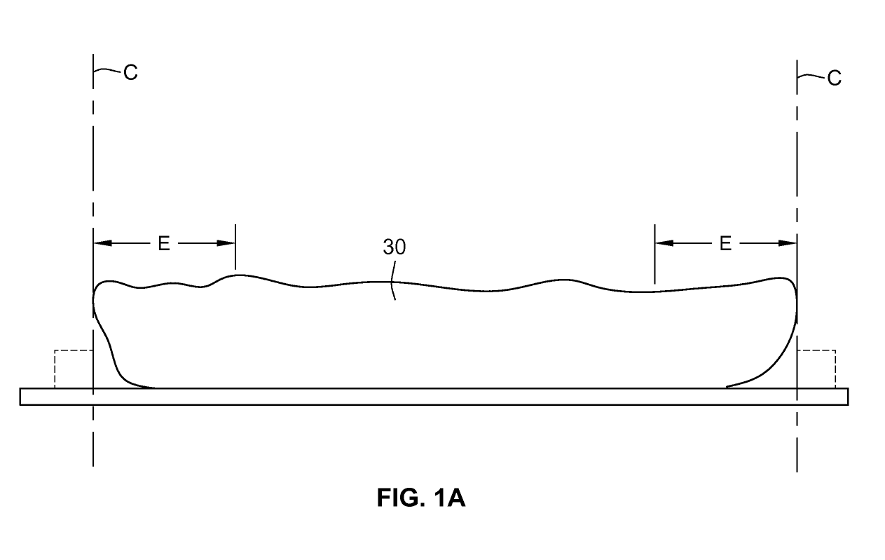

FIG. 1 is a perspective view of a commercial toaster 10 capable of simultaneously toasting several bread products at the same time. As set forth above, bread products refer to English muffins and English muffin halves, however bread products also include sliced breads, sandwich rolls, bagels, pita bread and flat bread. English muffin, English muffin halves and muffin are terms used interchangeably.

The toaster 10 is comprised of a six-sided cabinet 12, the sides of which are preferably thermally insulated to keep heat inside the toaster 10 and conserve energy but also to keep exterior surfaces at least relatively cool. A front face 13 of the cabinet 12 is provided with a rectangular opening 14 into the interior of the toaster.

Inside the cabinet 12, one or more elongated and electrically-heated infrared lamps 16 affixed to the top inside surface of the cabinet 12 emit infrared energy downwardly toward the bottom 17 of the cabinet 12 and onto the tops of English muffins or other bread products 30 slid into the toaster 12 on a spatula 18A. Alternate embodiments of the toaster 10 can use a gas-fired infrared burner, such as that disclosed in co-pending U.S. patent application Ser. No. 11/692,465, filed Mar. 28, 2007, and entitled “Infrared Emitting Gas Burner,” the contents of which are incorporated herein by reference. One or more bread products 30 can be batch-toasted together, i.e., at the same time. In an alternate embodiment, the toaster 10 includes one or more cool air blowers, as described in the applicant's co-pending patent application Ser. No. 12/407,691 entitled, “Toaster With Cooling Air Stream” filed Mar. 19, 2009, to also control muffin and bread product burning. The teachings of the applicant's co-pending patent application Ser. No. 12/407,691 are therefore incorporated herein by reference.

The spatula 18A moves one or more muffins in and out of the toaster 10 and is preferably comprised of a thermally insulating handle 20. In FIG. 1, the handle 20 is attached to a vertically-oriented front face 22 of the spatula 18A. Elongated guide rails 24 on opposite sides of the front face 22 extend from the back side (not shown) of the front face 22 and support a substantially planar wire mesh 26 constructed of heavy gauge wire. The wire mesh 26 supports bread products 30 to be toasted and allows crumbs to fall through the wire mesh onto an optional collection pan or surface on or just above the bottom side (not shown) of the cabinet 12. The wire mesh 26 also supports a product edge toasting shield 28.

It has been observed that when certain bread products with irregular surfaces are toasted under one or more IR sources such as those illustrated in FIG. 1, the edges of such bread products can tend to burn. The edges of English muffins are particularly susceptible to such edge burning, perhaps because the peripheral edges 32 are also irregular.

The terms, “edge” and “edge portion” are used interchangeably herein. The “edge” or “edge portion” of an English muffin are considered to be the surface of an English muffin, including valleys and ridges, exposed by slicing an English muffin in half, within about one-half inch or less of the outer-most edge or periphery of a particular English muffin. The “edge” or “edge portion” of other bread products like sliced bread, pita bread, pizza, bagels and sandwich rolls, are similarly considered to be the surfaces of a particular bread product that is within about one-half of an inch or less from the outer-most edge or periphery of such a product. In FIG. 1B, the “edge” of an English muffin half vis-à-vis the entire portion is thus reminiscent of an annulus in the region of the muffin face surface identified in FIG. 1B by the letter “E.”

It has also been observed and experimentally confirmed that edge burning of bread products like English muffins halves is reduced and/or eliminated when such a bread product is subjected to IR when the bread product is irradiated while it inside a walled compartment or pocket 29 of a bread product edge toasting shield 28, the walls of which have a height that extends above the height or thickness of a bread product. It is believed that the walls shield the bread product edge from infrared energy that would otherwise impinge on the edge at low angles of incidence from a nearby, adjacent IR source. In addition, or in the alternative, it is believed that the walls of the shield can tend to columnate, i.e., form into columns, infrared energy downward, i.e., so that it travels straight down. The problem of edge burning and the efficacy of edge shielding increases when multiple IR sources are used, such as is shown in FIG. 1, or when a planar IR source is used. Stated another way, the vertical walls of the edge shield 28, which extend upward and above the top surfaces of bread products like English muffin halves, reduce and even eliminate edge burning.

In FIG. 1, the bread product edge shield 28 is a baffle or matrix of rectangular or square-shaped pockets 29 formed by joining strips 31 together at right angles to each other. The vertically-oriented strips 31 act as walls to block IR. The bread product edge shield 28 should have a height such that the walls 31 extend upward and get as close as possible to the IR source 16 while retaining the ability to move the spatula 18A into and out of the toaster 10. Walls having a height less than the thickness of a bread product being toasted are ineffective in preventing IR from impinging on bread product edges.

The shield 28 can be formed from stamped, rolled, cast or molded metals. The shield can also be formed from high temperature plastic, as long as it is able to withstand operating temperatures found in toaster ovens and broilers. In other embodiments, the shield 28 can also be formed by joining discrete strips 31 to each other high temperature adhesives, brazing, welding or soldering. Ceramic and glass can also be used to form the shield 28.

In a preferred embodiment, individual, discrete strips 31 are formed to have slots (not shown) spaced apart from each other at regular intervals. The spacing between each slot defines the width and length of a pocket 29 into which an English muffin or other bread product is placed for toasting. The regularly-spaced slots formed into the strips 31 also have widths slightly greater than the thickness of the strips 31 in order to allow one strip 31 to slide into a similar slot formed in a second, orthogonal strip. The slots so formed in the strips have lengths one-half the height of the strips 31. The half-height, strip-thickness slots formed in each strip 31 thus enable two orthogonal strips 31 to be interlocked to each other with a “downward” facing slot in one strip engaging an “upward” facing slot formed in a second strip 31. In yet another embodiment described below, the edge shield is a section of a tube.

Experiments show that English muffin edge burning is reduced and/or eliminated when the muffins are toasted using infrared energy directed downwardly and but which does not impinge upon the muffin edge at low angles of incidence from an IR source or part thereof located outside a geometric cylinder defined by the outside the perimeter or edge of a bread product being toasted. An example of such a cylinder C, is shown in FIG. 1A.

For purposes of this disclosure, “low” angles of incidence are considered herein to be angles of incidence between about 0° and about 80-85 degrees measured relative to the horizontal plane defined by the plane defined by the wire mesh 26. IR strikes the muffin edges at a low angle of incidence if the IR passes into the geometric cylinder C, the inner diameter of which is defined by the muffin's outer edge, E and is at an angle between about zero and 80-85 degrees relative to horizontal. Stated another way, the edge shield 28 is configured, i.e., sized, shaped and arranged, to prevent infrared energy from impinging upon the edge E, of the English muffins from nearby IR sources.

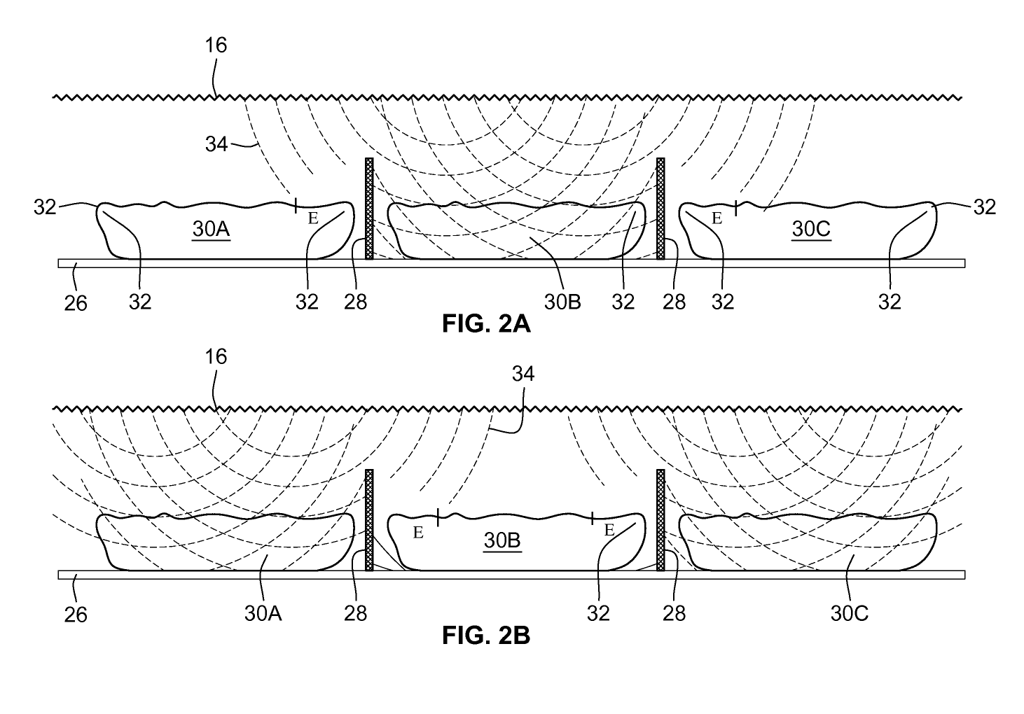

FIGS. 2A and 2B and FIGS. 3 illustrate how the edge shield 28 blocks infrared energy that would otherwise impinge on bread product edges at low angles of incidence. FIGS. 2A and 2B are views taken along section lines 2-2 in FIG. 1. Infrared energy emitted from the elongated infrared sources 16, is represented in the figures by broken lines that are identified by reference numeral 34 and which also represent the IR wave fronts.

In FIG. 2A the infrared energy wave fronts 34 show that infrared energy is emitted in all directions from the elongated IR source 16. Infrared energy emitted from the center or near-center portion of the IR source 16 is prevented from striking the rightmost edge portion 32 of the leftmost English muffin 30A. Infrared from the middle or center region of the IR source 16 is prevented from striking the leftmost edge portion 32 of the rightmost English muffin 30C. The edges 32 of the English muffins 30A and 30C are thus protected from low angle-of-incidence IR by the edge shield 28.

FIG. 2B is the same view shown in FIG. 2A but with the infrared radiation directed towards the middle English muffin omitted in order to more clearly show that the edge shield strips or walls 31 also protect edges 32 of the middle English muffin 30B from low incidence angle infrared.

FIG. 3 depicts the cross section of irradiation of all three muffin halves shown in FIGS. 2A and 2B. FIGS. 2A, 2B and 3 thus show that edges 32 of the muffins 30 are shielded from infrared energy wave fronts that would otherwise impinge on those edges 32 at low angles of incidence but for the presence of the strips or walls 31 that form the edge toasting shield 28.

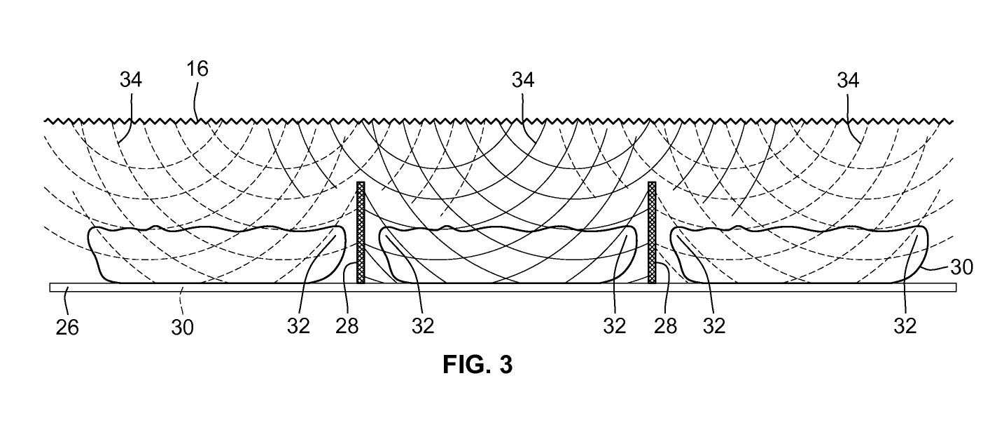

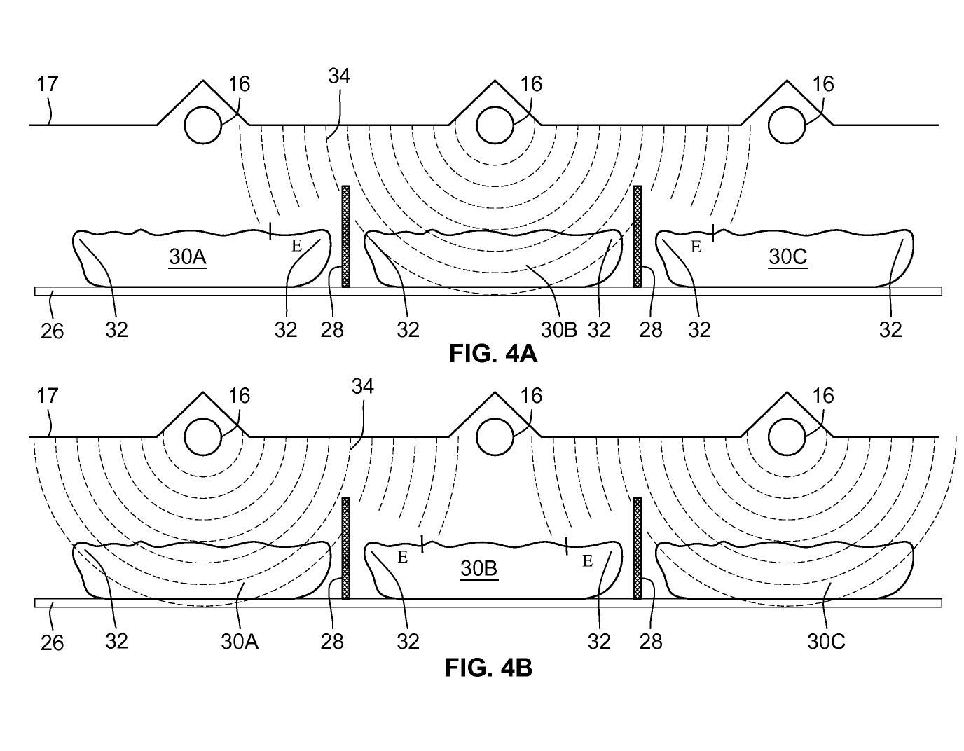

FIGS. 4A and 4B are views of the spatula 18A shown in FIG. 1 taken along section lines 4-4. In these figures, the infrared generating elements 16 are shown in cross-section and depicted as being circular. Infrared wave fronts 34 are emitted in a radial direction from the three IR sources 16. An IR reflector 17 above the IR sources 16 directs additional infrared energy downwardly, however, the reflected IR is usually IR absorbed from the IR sources 16 at a short wavelength and re-emitted as a longer wavelength IR. The re-radiated IR is not shown in the figure for clarity.

As with the depictions of infrared wave fronts 34 shown in FIG. 2A and 2B, in FIG. 4A, infrared energy 34 from the center infrared source 16 is blocked from striking the upper right-hand edge portion 32 of the leftmost English muffin half 30A. Similarly, infrared emitted from the center IR source 16 is prevented from striking the left edge portion 32 of the rightmost English muffin half 30C. In FIG. 4B, English muffin halves 30A and 30C are irradiated mostly from the left and right infrared sources respectively, however, infrared energy from those two outer sources 16 is blocked from striking the edges 32 of the centrally located English muffin half 30B by the walls of the bread product edge toasting shield 28.

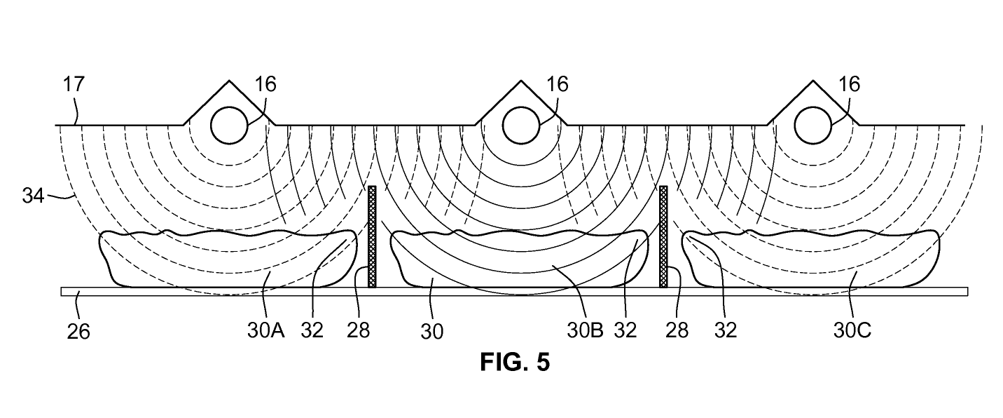

FIG. 5 illustrates the irradiation of all three muffin halves 30A, 30B and 30C by the three infrared energy sources 16. A close inspection of the edges 32 of each muffin half 30A, 30B and 30C reveals that the edges 32 are irradiated by infrared energy at an angle of incidence greater than about forty-five degrees relative to the geometric plane defined by the wire mesh 26.

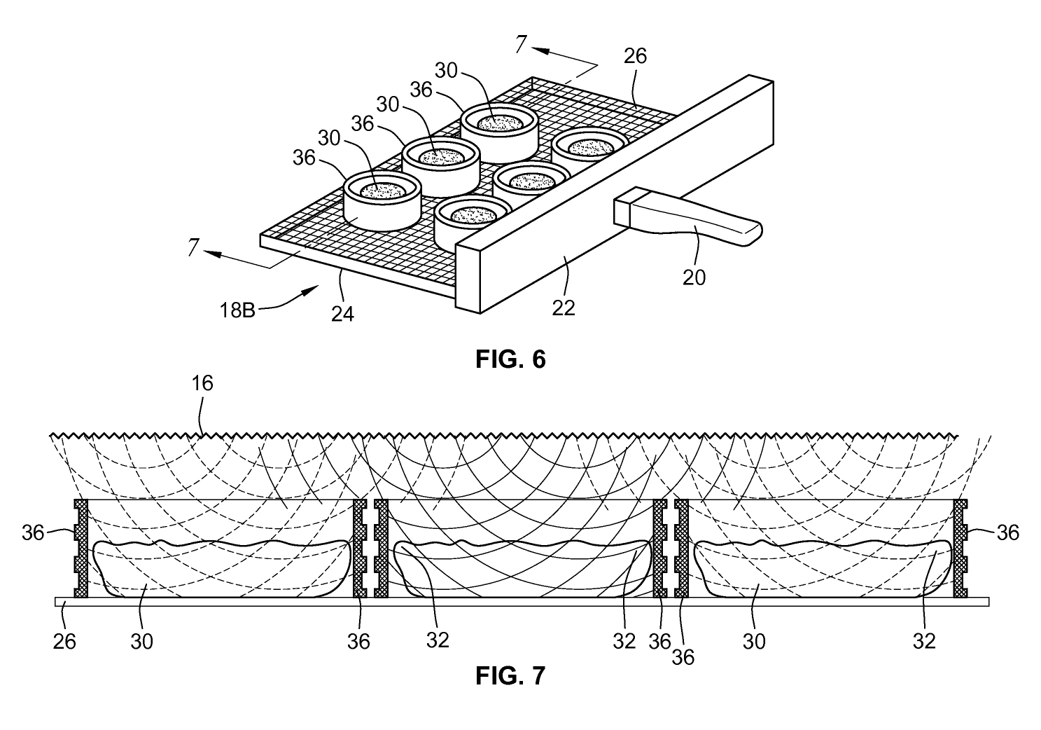

FIG. 6 depicts an alternate embodiment of a spatula 18B wherein several different bread product edge shields are embodied as sections or short lengths of cylindrical tubes 36, preferably made of aluminum. The cross-sectional shape of the tubes 36 substantially matches the circular or round cross-section of the bread products 30. When the spatula 18B of FIG. 6 is placed under the infrared energy sources 16 shown in FIG. 1, the edges of the English muffins 30 are similarly protected from infrared energy emitted towards the edges 32 at low angles of incidence. As with the embodiment shown in FIGS. 2A-2C, the height of the shields extends toward an IR source as close as possible while retaining the ability to move the spatula 18B into and out of the toaster 10. FIG. 7 shows that the low-angle IR is blocked by the tubes 36 that make up the edge shield.

Those of ordinary skill in the art will recognize that the cross-section of the pockets 29 formed by the edge shield 28 of FIG. 1 is different that the cross-sectional shape of the bread products 30 shown in the same figure. Conversely, the cross-sectional shape of the cylinders 36 shown in FIG. 6 are substantially the same as the cross-sectional shape of the bread products 30 shown in that figure. Experimentation has shown that the bread product edge burning is mitigated or eliminated whether the cross-sectional shape of the edge shield is the same or substantially the same or different than the cross-sectional shape of the bread product, so long as the angle of incidence of the infrared energy striking the edges is blocked such that the IR angle of incidence is greater than about eighty (80) degrees.

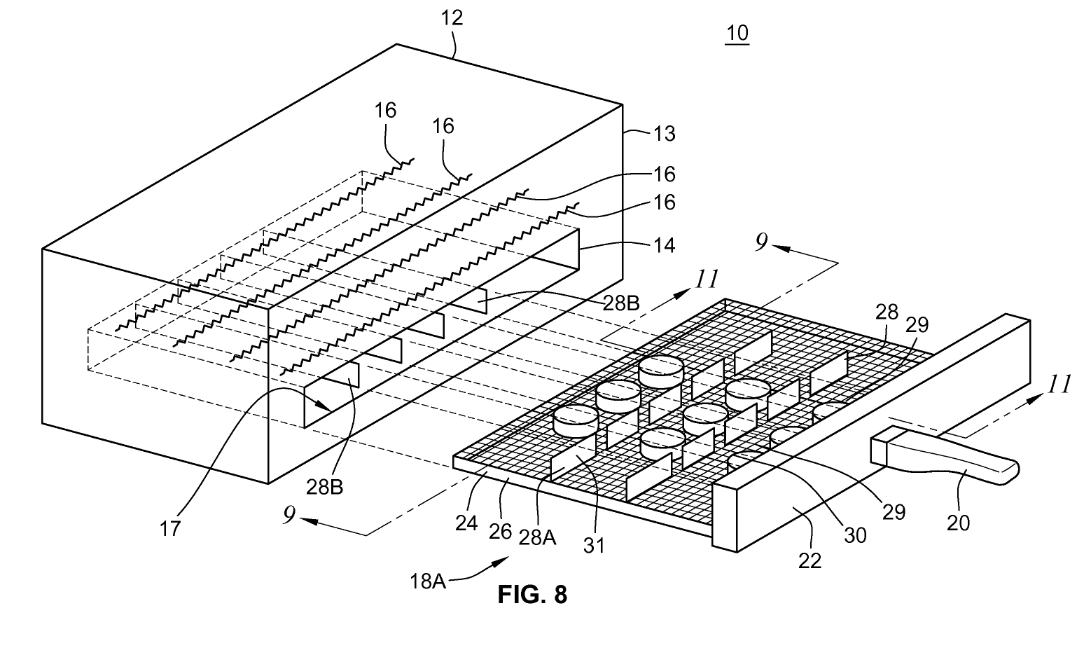

The bread product edge shields should extend upward as close as possible to the IR source 16 while retaining the ability to move the spatula 18A into and out of the toaster 10. In an alternate embodiment shown in FIG. 8, one set of walls 28B of a bread product edge like that shown in FIGS. 1-7 extends downwardly from an IR source. A spatula having the other set, i.e., the spaced-apart, upwardly-extending walls 28A on the spatula 18A, can be slid into the toaster cabinet 12 by virtue of the space between the spatula-mounted walls so that the cabinet-mounted walls fit into the spaces between the spatula-mounted walls.

As with the toaster described above, the toaster 10-1 in FIG. 8 is comprised of a cabinet 12 having a front face 13 with a rectangular opening and several IR heater mounted above the opening 14. Unlike the toaster shown in FIG. 1, the toaster 10-1 of FIG. 8 has several, downwardly-extending walls 28B attached to the cabinet 12 and which act as bread product edge toasting shields. Unlike the spatula shown in FIG. 1, the spatula 18A shown in FIG. 8 has several walls 28A which are orthogonal to the walls 28B in the toaster and which are spaced apart from each other as shown. The spacing between the spatula-mounted walls 28A is such that the cabinet-mounted walls 28B pass through the spaces between the spatula-mounted walls 28A when the spatula 18A is slid through the opening 14 in the front face 13. Once the spatula 18A is fully inserted into the toaster cabinet 12, the cabinet-mounted walls 28B that extend downwardly from the top of the cabinet opening, direct the IR emitted from the heaters 16 such that most of the emitted IR striking the bread products 29 is IR that is directed straight down.

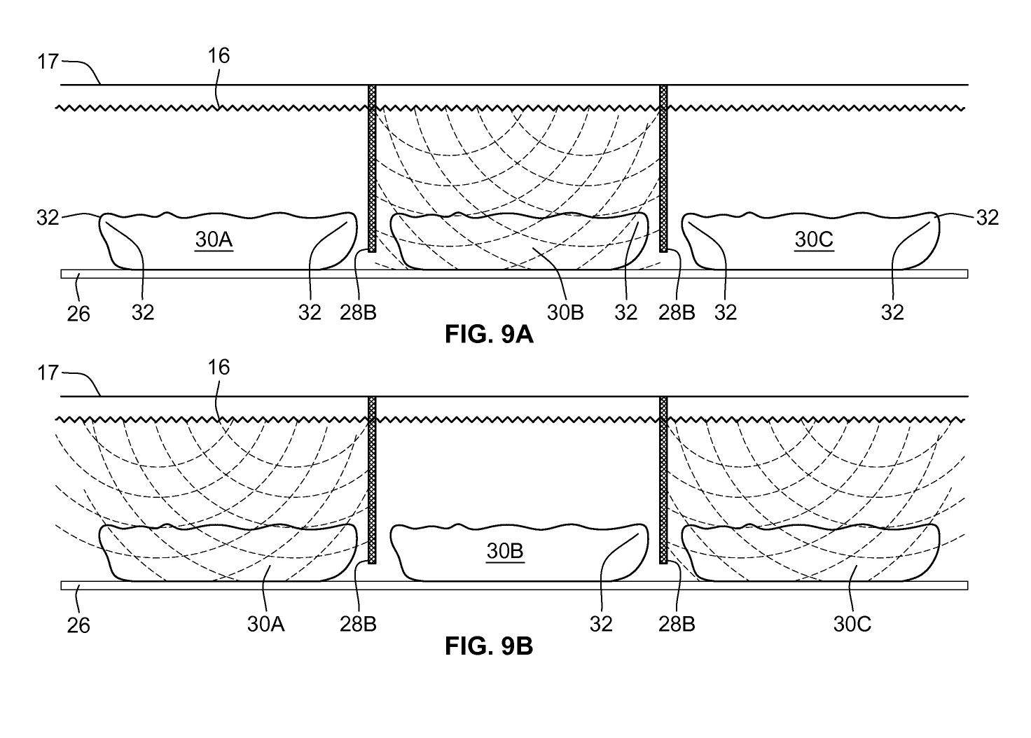

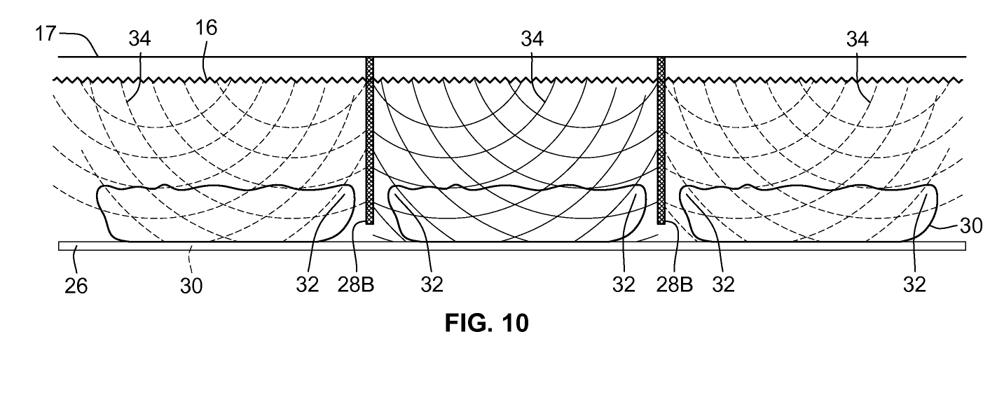

FIGS. 9A, 9B and 10 are side views of the toaster 10-1 of FIG. 8 taken through section lines 9-9 and show the walls 28B that extend downwardly from the top of the cabinet. FIGS. 9A and 9B show bread products beneath the IR element and the infrared wave fronts (shown in broken lines) emitted from the IR heating element 16 into three different pockets formed from the first part of the shield 28A attached to the spatula 18A and a second part of the shield 28B attached to the toaster cabinet 12. FIG. 10 shows how the edge portions 32 of the English muffin halves 30 are protected from IR emitted directly at them from the IR source 16.

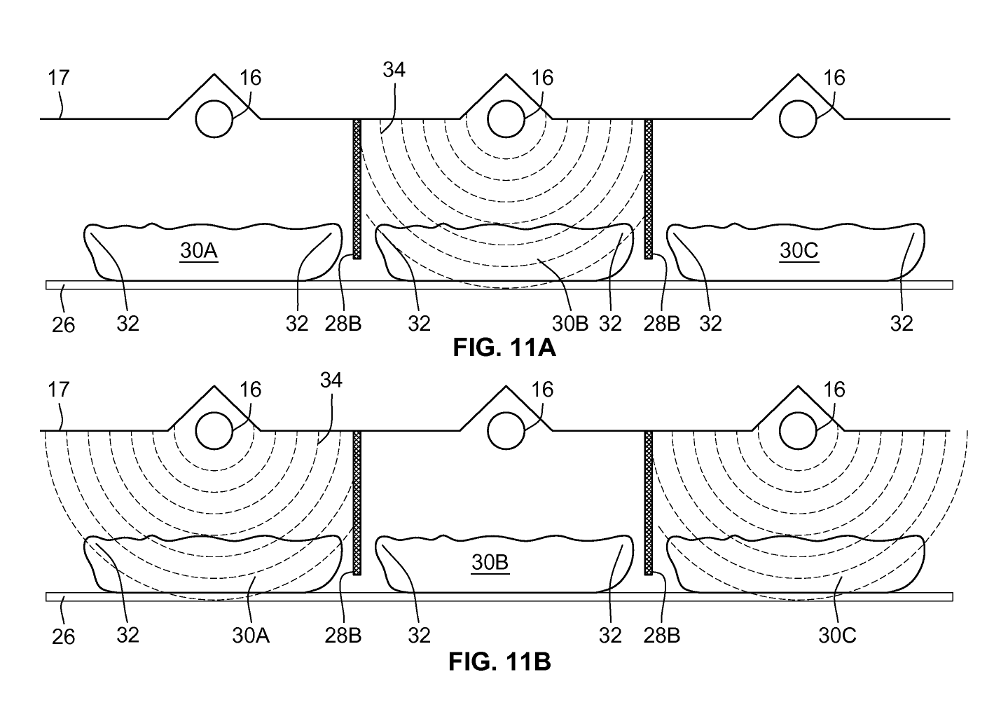

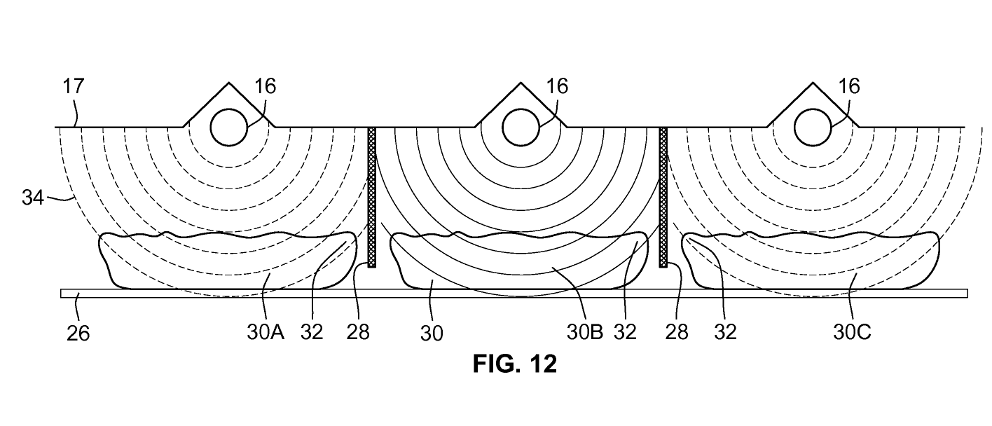

FIGS. 11A, 11B and 12 are views of the toaster 10-1 taken through section lines 11-11. They show the IR waves in broken lines and depict how the cabinet-mounted first portion 28A of the edge shield also prevents IR from striking the edge portions of muffins on the spatula 18A.

Those of ordinary skill in the art might recognize that the edge shielding provided by the downwardly-extending walls 28B depends on whether the walls 28B extend downwardly far enough to be below the top surface of a bread product to be toasted. Stated another way, the edge shielding efficacy of the downwardly-extending walls will depend on whether the walls extend below the level of the top of the bread product being toasted. Downward-extending walls that do not reach below the top of the bread product will be largely ineffective as edge shields.

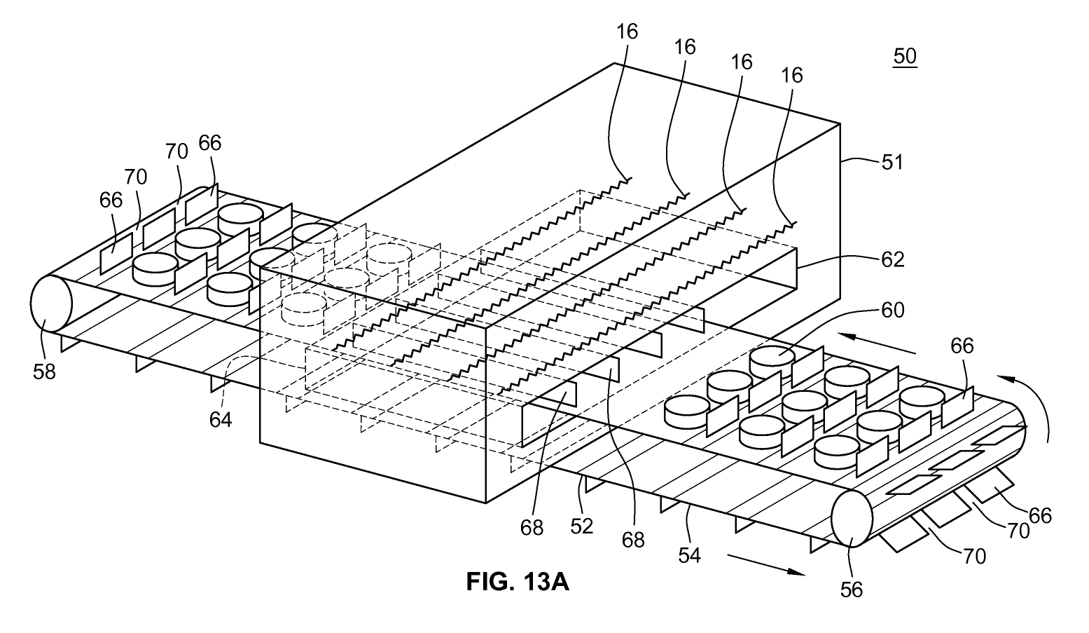

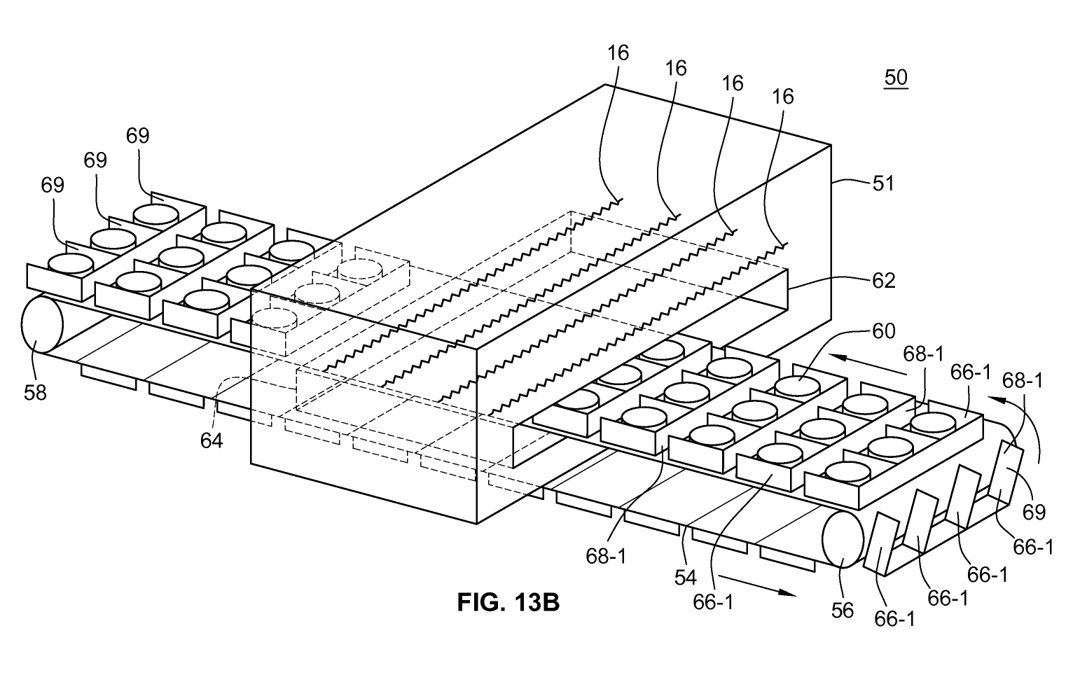

FIG. 13A shows how the separate parts of the edge toasting shield shown in FIG. 8, can be re-configured to be used in a first embodiment of a conveyor toaster 50. In FIG. 13A, a conveyor 52 (not to scale) is comprised of segments that form a segmented but nevertheless continuous belt 54 that travels around two, spaced-apart rollers 56 and 58, at least one of which is driven by a motor, which has been omitted from the figure for clarity. Bread products 60 to be toasted enter a first opening 62 in one side of the toaster cabinet 51, pass under a set of IR radiators 16 and exit from the toaster cabinet 51 through a second opening 64 on the opposite side of the cabinet.

Bread products 60 are toasted by IR emitted from the multiple different IR sources 16 in the toaster cabinet 51 but as described above, certain bread products are susceptible to having their edges burn. As with the edge shields 28 described above, pockets formed from walls block IR emitted at low incidence angles, preventing the bread product edges from burning. In FIG. 13A, the edge toasting shields are embodied as pockets formed by the conveyor-mounted, i.e., rotating, spaced-apart wall segments 66 that extend upwardly from the conveyor belt 54, and downwardly-extending walls 68 attached to the cabinet 51 adjacent the IR sources 16, and which are orthogonal to the conveyor-mounted wall segments 66. The cabinet-mounted walls 68 fit through spaces 70 between the rotating wall segments 66 such that the fixed wall segments 68 attached to the cabinet 51 and the rotating wall segments 66 attached to the conveyor form square or rectangular pockets inside the toaster cabinet 51, albeit with open corners where the cabinet-mounted walls 68 pass through the open spaces 70.

As the conveyor 52 rotates, wall segments 66 on the conveyor and the bread products 60 between them pass under infrared-emitting heaters 16, are toasted and exit the second opening 64. The bread products fall off the end of the conveyor 54 for consumption. Toasting without burning edges or edge portions can thus be performed continuously rather that in a batch mode facilitated by the toaster and spatulas shown in FIGS. 1-7.

FIG. 13B shows an alternate embodiment of the conveyor toaster 50 shown in FIG. 13A. Toasting edge shields are embodied as generally U-shaped compartments 69 formed by joining an elongated wall segment 68-1 to one or more short wall segments 66-1 as shown in the figure. The U-shaped compartments 69 formed by an elongated segment 68-1 and a shorter, orthogonal segment 66-1 effectively form a closed, rectangular edge-shielding compartment when two adjacent U-shaped compartments 69 pass into the toaster opening 62. The edges of the bread products 60 that pass under the infrared heaters 16 are thus protected from edge-burning infrared energy.

Those of ordinary skill in the art will recognize that conveyor-mounted edge shields can also be implemented by attaching box-shaped compartments having all four sides attached to each other at the corners by attaching them to a correspondingly wide segment of the conveyor 52. Another embodiment includes attaching the elongated wall segments 68-1 to every other conveyor segments and attaching, orthogonal short wall segments 66-1 to every other intervening segment.

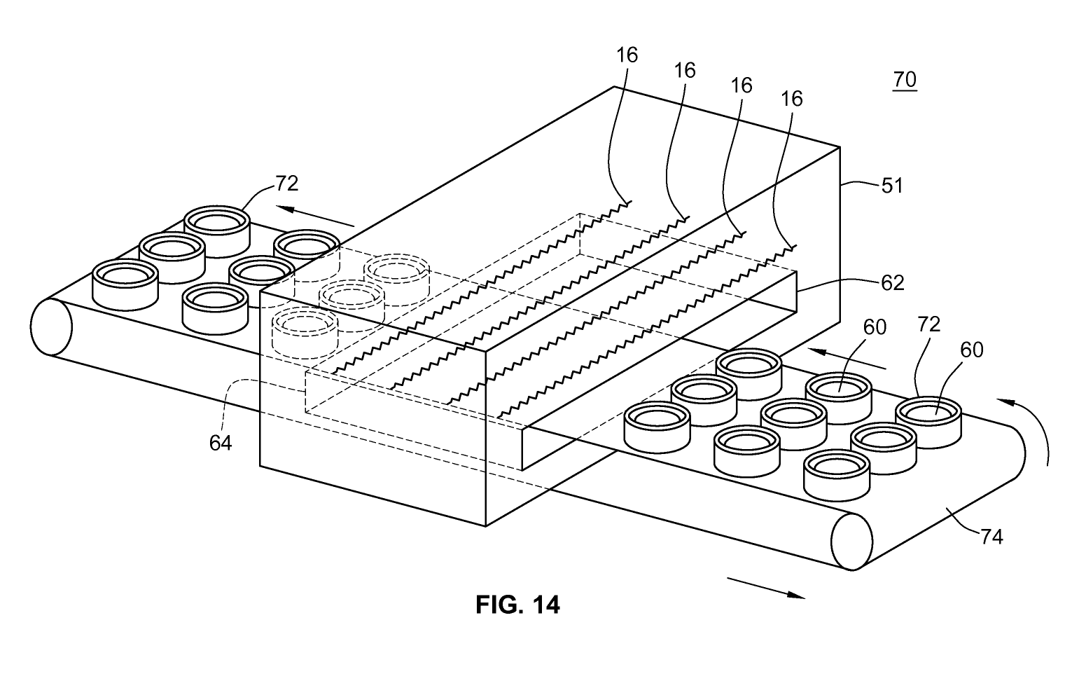

FIG. 14 illustrates a second embodiment of a conveyor toaster 70. In this figure, the edge toasting shields are embodied as short cylinders 72 attached to segments of segmented rotating conveyor belt 74 (segments not shown but well known to those of ordinary skill) rather than having walls fixed to the belt as shown in FIG. 13. As with the spatula and cylinders shown in FIG. 6, the cylinders 72 shown in FIG. 14 block IR directed at the bread product edge portions 32 at low angles of incidence. The cylinders 72 are preferably metal or ceramic, since they are subjected to intense energy, or a suitable high-temperature plastic. As with the spatula and cylinders shown in FIG. 6, the cylinders used in a conveyor toaster shown in FIG. 14 have a height sufficient to block IR emitted toward the bread product edges at low angles of incidence.

In one embodiment, the interlocking strips or walls used to make the edge shield 28 shown in FIG. 1 are metallic. High temperature plastics, ceramic or etched or clear PYREX® glass can also be used to make the edge shield 28. Similarly, the cylinders shown in FIG. 6 and FIG. 14 can be made from metal, high temperature plastic, ceramic or PYREX® glass. In a preferred embodiment, the cylinders are cast aluminum. In one embodiment, the surface color of the strips or walls and of the tubes shown in FIG. 6 is black, however, a matte finish or a brushed stainless steel can also be used. Glass edge shields can be clear or the surfaces etched.

A method of cooking bread products to control edge burning using one of the spatulas and/or edge shields depicted in the figures includes a first step of irradiating at least a first side of the bread product while shielding the edges using a bread product infrared energy edge shield such as those shown in FIGS. 1 and 6. In an alternate embodiment, a cooling air stream as described in the applicant's co-pending application Ser. No. 12/407,691 is also used albeit with the air stream of this application being directed downwardly onto the bread product 30.

A method of cooking bread products to control edge burning using the conveyors depicted in FIGS. 13 and 14 includes the steps of placing bread products on the conveyors and adjusting conveyor speed and the energy emitted from the radiators 16 until the bread products exiting the conveyor are of the desired color.

The foregoing description is for purposes of illustration only. The true scope of the invention is set forth by the appurtenant claims.

What is claimed is:

1. An apparatus for heating bread products by an infrared heating source, the apparatus comprising:
a toaster having first and second openings and an infrared energy source;
a conveyor passing through at least one of the first and second openings and past the infrared energy source;
a bread product edge shield attached to the conveyor, the bread product edge shield being sized, shaped and arranged to receive a bread product therein and to prevent infrared energy emitted from the infrared energy source from impinging on the edges of bread products at low angles of incidence.

2. The apparatus of claim 1, wherein the bread product edge shield is comprised of a plurality of spaced apart walls attached to the conveyor, said apparatus being further comprised of a plurality of spaced-apart walls attached to said toaster, the walls attached to the conveyor being substantially orthogonal to the walls attached to the toaster and spaced apart from each other to allow walls attached to the toaster to pass between them.

3. The apparatus of claim 1, wherein the conveyor is segmented and wherein the bread product edge shield is comprised of at least one cylinder attached to at least one segment of said conveyor.

4. The apparatus of claim 2, wherein the spaced apart walls attached to said toaster extend from the infrared energy source downwardly toward the conveyor and wherein the spaced apart walls attached to the conveyor extend upwardly from said conveyor.

5. The apparatus of claim 1, further comprising a cabinet having first and second opposite sides, the first side having a first opening, the second side having a second opening, the conveyor extending through the first and second openings.

6. The apparatus of claim 5, wherein walls attached to the conveyor are oriented to be parallel to a direction of travel of said conveyor.

7. The apparatus of claim 5, wherein walls attached to the conveyor are oriented to be orthogonal to a direction of travel of said conveyor.

8. The apparatus of claim 1, wherein the bread product edge shield is comprised of a plurality of U-shaped compartments.

9. The apparatus of claim 1, wherein the bread product edge shield is comprised of a rectangular compartment, formed from separate wall segments that extend vertically from a plurality of conveyor segments, which comprise the conveyor.

10. The apparatus of claim 1, wherein the conveyor is comprised of segments that form a belt, which travels around spaced-apart rollers.

11. The apparatus of claim 5, wherein the conveyor is configured to pass under a plurality of infrared emitters inside the cabinet.
